(19) United States
(12) Patent Application Publication
(10) Pub. No.: US 2007/0080845 A1
(43) Pub. Date: Apr. 12, 2007

(54) Universal remote control device with touch screen

(75) Inventor: Frank Amand, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/577,899

(22) PCT Filed: Oct. 21, 2004
(86) PCT No.: PCT/IB04/52160

§ 371 Date: May 1, 2006

(30) Foreign Application Priority Data
Nov. 4, 2003 (EP) 03104074.4

(51) Int. Cl. G08C 19/12; H04L 17/02

(52) U.S. Cl. 341/176

(57) ABSTRACT

A universal remote control device (2) is provided for replacing original remote control devices for remote controlling different appliances. The universal remote control device (2) comprises a remote control signal emitter (8) and receiver (16), a memory component (106), a touch screen (6) and a camera (20). If the functionality of an original remote control device needs to be added to the universal remote control device (2), an image (14) is taken of the original remote control device and the functions corresponding with the buttons on the original remote control device are assigned to the corresponding sub-images of the buttons of the image (14). This can be performed in a fast learning step, e.g. by detecting the remote control signal emitted by the original remote control device, and storing a fingerprint of this signal to be able to reproduce it if the image of the button is pressed on the universal remote control device. This allows a fast configuration of original remote control devices, and makes the universal remote control device very user-friendly.

The present invention relates to a universal remote control device and method of operating the same. More specifically, the present invention relates to a universal remote control device having an improved flexibility and allowing easier configuration.

In today's world, many consumer electronics devices have there own distinct and non-standard remote control device. The number of remote control devices present in an average household has risen significantly during the past tens of years. Very often remote control devices are present for television, DVD, hi-fi, CD-player, MP3 player, telephone answering machine, etc. To avoid that every household ends up with many remote control devices which all have to be stored somewhere, in the past, universal remote control devices, also called replacement remote control devices, have been developed to integrate the functionality of all remote control devices into a single universal remote control device.

Different types of universal remote control devices exist on the market. Universal hard key based remote control devices are a cheap solution, but they lack flexibility. Furthermore, configuration of these universal remote control devices is often non-intuitive and a thick instruction guide with pages of code-sets is necessary. More specifically, the manually configuring of a universal remote control device is often very labour-intensive: for every function, all possible signals need to be scanned and the user needs to tell the universal remote control device whether the found signal is the appropriate one.

In more advanced remote control systems, touch screen based remote control devices offer a flexible solution. They allow the incorporation of remote control devices of consumer electronics without having the problem of having lack of or having spare universal hard keys. Configuration of these remote control devices has improved, but is still difficult, especially for novice users. In more advanced universal touch screen remote control devices, configuration can be performed by connecting the universal touch screen remote control device to the Internet and by downloading a set of configurational data for the remote control device that needs to be added to the universal remote control device. A disadvantage of these devices is that a PC tool with Internet connection is needed to obtain an easier configuration and to exploit the full flexibility of these systems.

Other examples of advanced universal remote control devices perform the configuration of additional remote control functions for an additional electronic apparatus by placing the universal remote control device and the additional remote control device of the appliance face to face, transferring the remote control signal from the additional remote control device to the universal remote control device and storing a corresponding code in the universal remote control device. For example, the universal remote control device comprises an infrared receiver and has a learning mode wherein a key of the universal remote control device is selected repetitively and a corresponding key of the additional remote control device is pressed, causing a command code to be transmitted to the universal remote control device and to be associated with the selected key.

WO 01/39150 describes an example of the above mentioned advanced universal remote control devices, wherein the learning function is not performed by placing the remote control device of the appliance face to face with the universal remote control device, but wherein the universal remote control device receives the corresponding command codes using a PC having an IR transmitter, which is very useful if the original remote control device of an electronic apparatus is not available. Such IR transmitters are currently available and may for example be connected to a serial port of the PC. The command code can be received by the data processing device, e.g. using a CD-ROM comprising these codes or by downloading these command codes via a communication network. WO 01/39150 furthermore describes the possibility of an automatic learn mode, wherein the universal remote control device selects the target keys on the universal remote control device all in turn in a fixed sequence known by the user.

A disadvantage of the above described universal remote control device is that both use and configuration are still not very user-friendly, as selection during operation and/or configuration of the correct buttons on the universal remote control device is not transparent, the buttons of the universal remote control device often having a different or inadequate description or position, compared with the description or position of the control buttons on the original remote control device. This is especially difficult for users already acquainted with the original remote control device. Similar problems may arise if new features are introduced in consumer electronic devices or if new types of consumer electronic devices are introduced on the market.

It is an object of the present invention to provide a flexible universal remote control device and method of operating the same that allows a more user-friendly use including a more user-friendly configuration of original remote control devices of electronic apparatus.

The above objective is accomplished by a method and device according to the present invention.

The invention relates to a universal remote control device for controlling a plurality of electronic appliances. The universal remote control device comprises means for receiving an image of a first remote control device, a touch screen, a signal detector and a processing means. The touch screen is adapted for displaying the image of the first remote control device. The signal detector is adapted for receiving first remote control signals associated with at least one control button of the first remote control device. The processing means is adapted for recognising control buttons on the image of said first remote control device and furthermore is adapted for associating second remote control signals corresponding to the first remote control signals with the image of the recognised control buttons.

The means for receiving an image of the first remote control device may be a camera for capturing an image of said first remote control device.

Furthermore, the universal remote control device may comprise a memory comprising a database of pre-stored command codes.

The universal remote control device may also comprise means for operating as a mobile phone. For such device, the means for receiving an image and the touch screen may be adapted for being used for graphic multimedia messaging service (MMS) functions. Furthermore, the touch screen may also be adapted for being used as keyboard for mobile phone functions.

In a second aspect, the invention also relates to a method for updating a universal remote control device for controlling a plurality of electronic apparatuses. This method comprises displaying an image of a first remote control device on a touch screen of the universal remote control device, the image showing images of buttons of the first remote control devices, applying a learning function to an image of at least one of the buttons of the first remote control device wherein applying the learning function comprises recognising said at least one of the buttons of the first remote control device on the displayed image, detecting a first remote control signal associated with said recognised at least one of the buttons of the first remote control device after actuation of said at least one of the buttons of the first remote control device, and associating a second remote control signal corresponding to the first remote control signal with the image of the recognised control button.

The method may furthermore comprise capturing the image of the first remote control device. This image may be stored. The method for updating a universal remote control device may furthermore comprise updating the universal remote control device by retrieving pre-stored command codes from a database. This database of pre-stored command codes may be stored in a memory of the universal remote control device. The pre-stored command codes may be retrieved by connecting to an external source comprising a database of pre-stored command codes.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

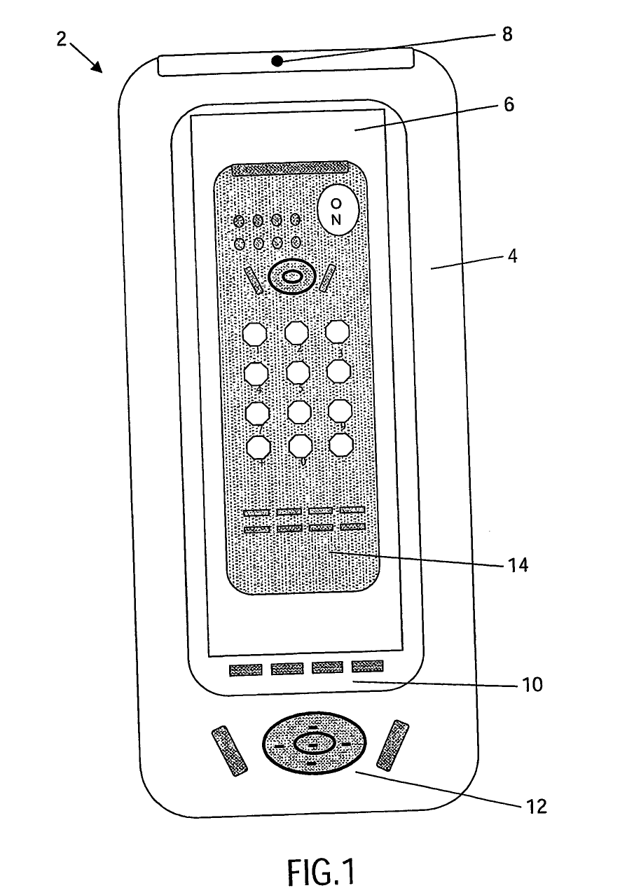

FIG. 1 is a schematic representation of a front view of a universal remote control device according to an embodiment of the present invention.

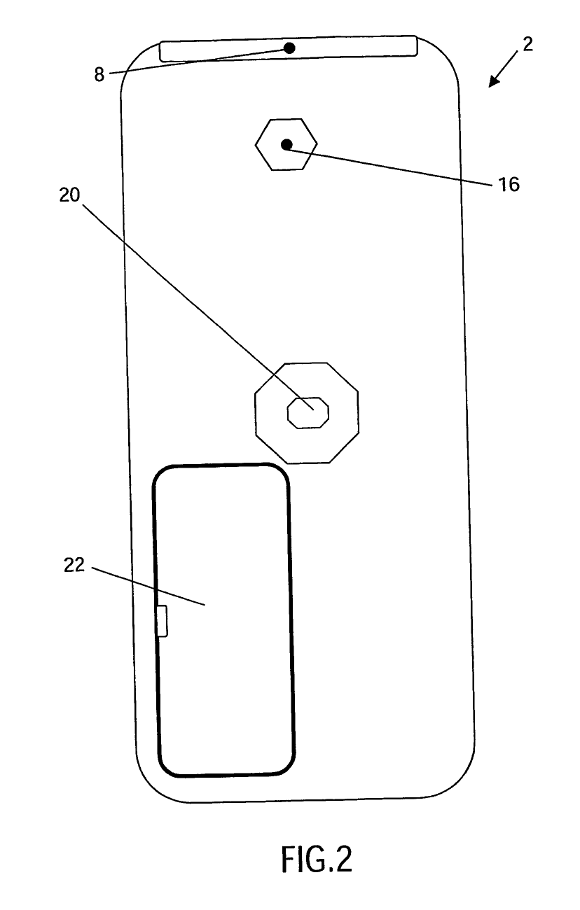

FIG. 2 is a schematic representation of a back view of a universal remote control device according to an embodiment of the present invention.

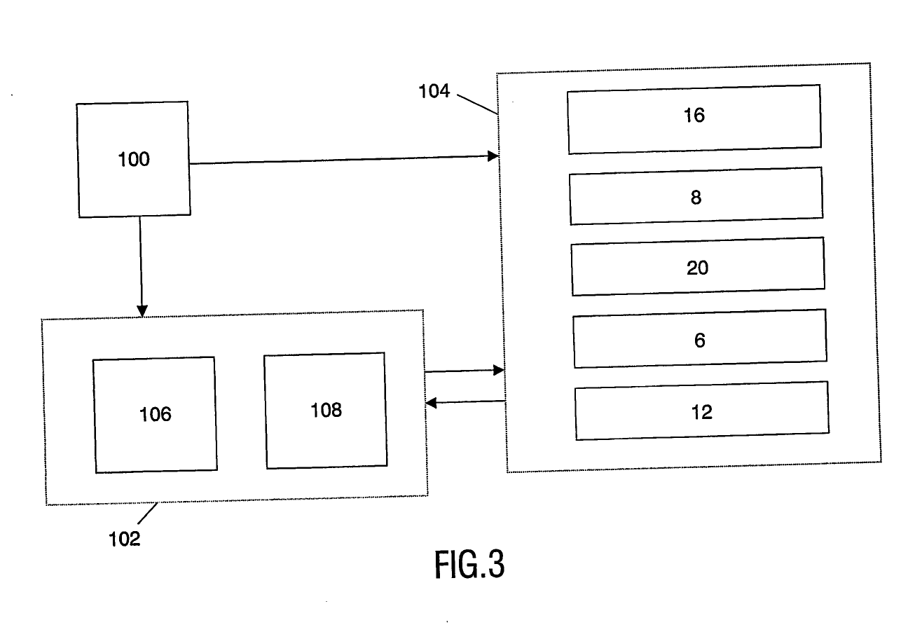

FIG. 3 is a diagrammatic representation of components of a universal remote control device in accordance with an embodiment of the present invention.

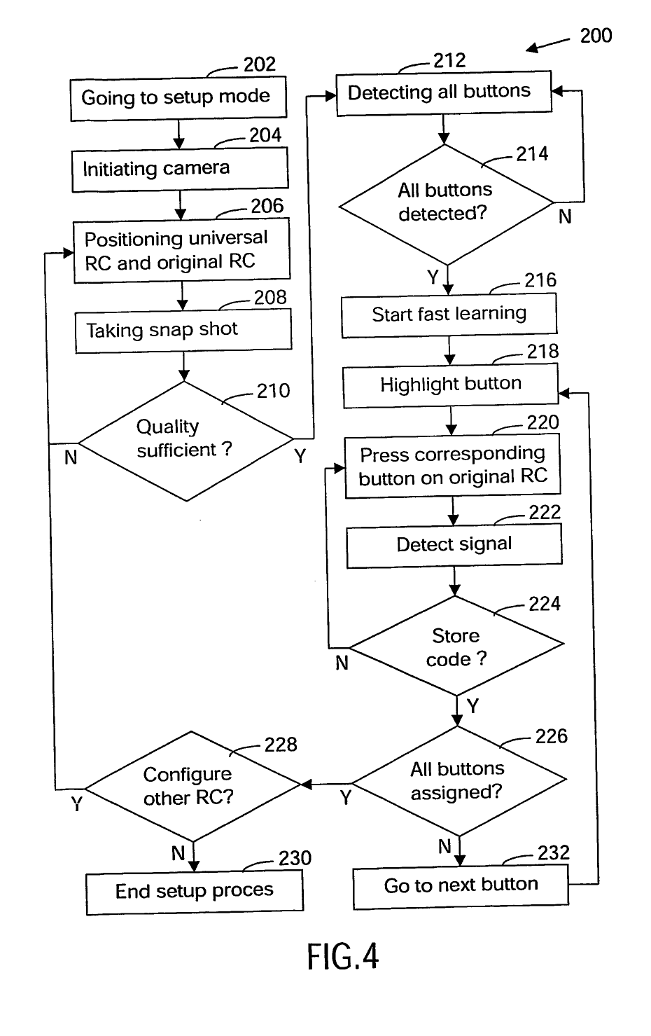

FIG. 4 is a flow chart of a method for updating a universal remote control device in accordance with an embodiment of the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

FIG. 1 shows a front view of a first embodiment of a universal remote control device 2 according to the present invention. It shows a universal remote control device 2 having a housing 4 and a display 6. The universal remote control device 2 can be used for remote controlling a variety of electronic apparatus adapted for being remote controlled, e.g. a television, a DVD, a CD player, a hi-fi system, . . . . The number of devices that can be controlled by the universal remote control device 2 is in principle unlimited, and is practically determined by the extent of a memory component (not shown on FIG. 1) which is part of the universal remote control device 2.

The universal remote control device 2 furthermore comprises a signal emitter 8, a display control panel 10 to configure and regulate the display 6 and a local control panel 12 to control some functions of the universal remote control device 2. The display 6 shows an image 14 of an original remote control device of an electronic apparatus that is to be controlled by the universal remote control device 2. The term “original remote control device” is referring to the remote control device that is or was used to remote control the electronic apparatus prior to incorporating its functions in the universal remote control device 2 described in the current invention. This can be either the remote control device delivered with the electronic apparatus, a substituting remote control device or another universal remote control device that the user wants to replace.

Furthermore, a signal emitter 8 can be seen. The universal remote control device 2 also comprises a signal receiver 16 (shown in FIG. 2), which is preferably situated at the back of the universal remote control device 2. This position will ease the incorporation of functions of other remote control devices as it will allow to position both remote control devices in upward position. The signal receiver 16 and emitter 8 are preferably wireless receivers and emitters whereby the word “wireless” should be interpreted widely and includes optical, infra-red, ultraviolet as well as radio frequencies, especially short range radio protocols, e.g. Bluetooth™. Further the term “emitter” or “receiver” is not limited to a single item or units working with a single protocol but may be multimode emitters and receivers, e.g. both infra red and Bluetooth compatible. They can be any signal receiver and emitter working with any electromagnetic radiation that can be used for remote controlling. For remote controlling, often infrared emission is used with frequencies between 20 kHz and 100 kHz. In order to be able to operate different electronic appliances having means for being remote controlled with signals within the above frequency range, the universal remote control device 2 has a signal emitter 8 covering this whole range. As the signal receiver 16 should be able to detect the signals of the corresponding original remote control devices, the signal receiver 16 also has to cover this range. The display 6 used in the universal remote control device 2 according to the present invention is a touch screen, often, but not limited to, an LCD-based touch screen. Another example of a display type that can be used is an OLED display. The display 6 may be a monochrome screen having grey levels or a colour screen. The display 6 is, amongst other things, used for displaying the original remote control device of an appliance. Therefore, the size and shape of the display is preferably such that most common remote control devices can be easily displayed, e.g. it may have an elongated rectangular shape.

FIG. 2 shows a back view of the first embodiment of the remote control device 2 according to the present invention. The signal receiver 16 and the signal emitter 8 can be seen. Furthermore, on the back of the universal remote control device 2, a small camera 20 can be optionally introduced to allow recording of images of original remote control devices of which the functions need to be introduced in the universal remote control device 2. A cover 22 covers the power supply of the universal remote control device 2. Alternatively, a connection may be provided, e.g. to a personal computer for downloading such an image.

The camera 20, introduced at the back of the universal remote control device 2, may be any type of small camera. Typical examples of cameras 20 that can be used are CCD cameras or CMOS cameras, comparable to those used as webcam or in mobile telephones having a graphic multimedia messaging service function. The resolution of the camera used should allow imaging of the different buttons of the original remote control device. This typically can be e.g. 240×320 pixels or, as a rectangular shape is preferred, e.g. 200×600 pixels. The camera 20 is preferably mounted at the back of the universal remote control device 2 in order to be able to capture an image 14 of the original remote control device and configure the universal remote control device 2 while the image 14 has the same orientation as the original remote control device. This allows a configuration mode which is user-friendly.

FIG. 3 shows a schematic diagram of components of the universal remote control device 2 according to the first embodiment. The device comprises a power supply 100, a processing part 102 and an input/output part 104.

The power supply 100 may comprise a set of batteries and supplies power to the driver electronics of the different other components of the universal remote control device 2.

The processing part 102 comprises a memory 106 and an image recognition tool 108. The memory 106, may be any read/write random access memory or non-volatile flash memory available. The capacity of the memory 106 is preferably such that configuration data of a large number of remote control devices can be incorporated in the universal remote control device 2 and that a large number of learnable codes can be stored. The image recognition tool 108 may be powered by a neural network. These are analytical techniques modelled approximately on what is perceived as the processes of learning in the cognitive system and the neurological functions of the brain. Neural networks are capable of predicting new observations from other observations after executing a process of so-called learning or training from existing data. The neural networks that can be used in this invention, may be designed specifically for the problem of image recognition.

The input/output part 104 of the universal remote control device 2 comprises the touch screen display 6, the local control panel 12 and the signal emitter 8, all used during operation of the universal remote control device for controlling an electronic apparatus, and furthermore the camera 20 and the signal receiver 16, which are components used during configuration of original remote control devices. All these components have their own driver electronics and are powered by the power supply 100.

In controlling operation of the universal control device 2, the image 14 of the appropriate original remote control device corresponding with the electronic apparatus that the user wants to remote control is evoked from the memory 106. This may be performed by selecting the corresponding electronic apparatus from an opening menu on the universal remote control device 2. The electronic appliances may be represented in the opening menu by name or, in a more advanced version, may be represented by their image, which can be incorporated using the camera 20 present at the back of the universal remote control device 2. Once the image 14 of the original remote control device of the electronic apparatus that is to be used is on the touch screen display 6, the user can use this image 14 as a replica of the original remote control device. If an imaged button is touched on the touch screen 6, a fingerprint code of the original remote control code is evoked from the memory 106. This is sent to the signal emitter 8, by which the corresponding electromagnetic, e.g. infrared, signal is emitted.

A method 200 for configuring the universal remote control device 2 if an original remote control function for an appliance is to be added to the universal remote control device 2 is now described, with reference to FIG. 4 showing a flow chart of the different steps which may be performed during configuration.

In step 202, the universal remote control device 2 is switched to set-up mode, e.g. by pressing a dedicated key or key-combination on the local control panel 12 of the universal remote control device 2. To avoid unwanted initiation of this function, it is preferred that a relatively long press on the set-up hard button is necessary, e.g. a 3 second press. The system then goes in set-up mode. In another embodiment, going to set-up mode may be performed by removing a cover for protecting camera 20. Method 200 proceeds to step 204.

In step 204, the camera 20 at the back of the universal remote control device 2 is initiated. During controlling operation of the universal remote control device 2, the camera 20 is not working. This initiation step may comprise opening a cover, by which the camera 20 and more specifically its lens may be protected during controlling operation. The camera 20 then goes in preview mode, showing what is captured on the display 6. Method 200 proceeds to step 206.

In a configuration step 206, the universal remote control device 2 is held above the original remote control device of the appliance, preferably pointing to the same direction. By doing this, an image 14 of the original remote control device of the appliance is captured by the camera 20 and shown on the display 6. Method 200 then proceeds to step 208.

In step 208 the user is asked to press a capture button, e.g. on the local control panel 12, so that the preview image 14 of the original remote control device is frozen. The brightness and contrast of the image 14 can be adjusted automatically. Method 200 proceeds to step 210.

In step 210, the user is asked whether the snapshot image 14 is of sufficient quality. This can either be confirmed, leading to the initiation of image recognition in step 212, or be denied. In the latter case, the method proceeds to step 206 again and the user is asked to take a new snapshot until a sufficiently good image 14 of the original remote control device is obtained.

In step 212, detection of the different buttons displayed on the snapshot image 14 of the original remote control device is performed using an automated algorithm. This is performed by the image recognition tool 108. These means can e.g. be powered by neural networks. Using these means, the different images of buttons are recognised and then indicated e.g. by a highlighted circle.

In step 214, the user is asked to confirm that all required buttons are indicated. It is to be noted that it is not necessary that all buttons are indicated if the user does not wish to associate remote control functions to all buttons. In other words, if all buttons to which a corresponding function is to be assigned are indicated, the user can give a positive response to the question and proceed to step 216. If this is not the case, method 200 proceeds to step 212 whereby the image recognition tools are used again, after adjustment of sensitivity. This recognition step is performed till at least all required buttons are indicated.

In step 216, the universal remote control device 2 starts a fast learning procedure. Therefore the universal remote control device 2 removes all indications of buttons, e.g. highlighted circles, on the image 14 of the original remote control device, and consequently proceeds to step 218 wherein a first button is selected.

In step 218 the selected button is highlighted, e.g. by a highlighted circle around it. The method 200 further proceeds to step 220.

In step 220, the user is asked to press the corresponding button on the original remote control device, having the same look and the same position as the highlighted imaged button of the image 14 of the original remote control device, as the image 14 and the original remote control device have the same orientation. The imaged button having the same look and the same position as the original button on the original remote control device, leads to an improved and easier configuration as the required buttons to press are easier recognisable. This is independent of the brand or the type of the original remote control device, as the image 14 is not a look-alike image from a database of images of remote control devices which would lead to the necessity to include images of all remote control devices of all types and all brands in a database—but it is a snapshot image 14 that is taken directly from the original remote control device using the camera 20 at the back of the universal remote control device 2.

In step 222, the signal of the original remote control device is received by the signal receiver 16, if the user has pressed the corresponding button on the original remote control device according to the step 220. The user may be alerted by a sound signal from the universal remote control device 2, about the moment the signal has been detected, to avoid unnecessary waiting times. Method 200 then proceeds to step 224. If no press on the button is given within a predetermined time period, method 200 also proceeds to step 224.

In step 224, the user is prompted with the status of the detection, within a predetermined time or after receipt of the signal. The user is asked to confirm the detection. If in the previous steps no button was pressed or no signal was detected, this is indicated, allowing the user to correct and redo the signal assignment (step 220) or allowing the user to leave certain imaged buttons without function. This can be performed for functions that are only seldom used or for functions that should not be available for every user. Leaving imaged buttons without function could be used to prevent e.g. kids from disordering e.g. the television, such as changing the image properties. In a specific embodiment of the invention, the availability of a full or limited version of the original remote control device may be controlled by a user password, to be inserted during use of the universal remote control device 2. If in step 224 it is decided that the detected code is incorrect, e.g. the user did press the wrong button or no signal was detected while it should, the method returns to step 220, and a new detection trial is performed. If the detected signal corresponds with the signal that needs to be associated to this button, a fingerprint code of the detected signal is stored and assigned to the corresponding imaged button of the image 14 of the original remote control device on the touch screen 6. This fingerprint code will, in operation mode of the universal remote control device 2, lead to emitting a remote control signal by the universal remote control device 2 upon pressing the touch screen display 6 on the imaged button of the image of the original remote control device, whereby the remote control signal that is emitted corresponds with the remote control signal assigned to the corresponding button of the original remote control device.

After storage of the fingerprint code, method 200 proceeds to step 226. In this decision step 226, the user is asked whether all required buttons are assigned or not. If the assignment is complete, method 200 proceeds to step 228. If not, the method 200 proceeds to step 232, wherein the learning function proceeds to the next button and starts the assignment of a fingerprint code to this button, therefore proceeding to step 218.

In decision step 228, the user is asked whether another original remote control device needs to be configured. If this is not the case, the set-up process is finished in step 230. If another original remote control device needs to be configured, method 200 proceeds to step 206 and the configuration process for the other original remote control device starts by asking to position the remote control device so a good snapshot can be taken. The whole configuration process is then repeated.

In step 230 the set-up process is finished.

If only one or a few additional buttons need to be installed, e.g. if after some time of use, a feature of an electronic device is used more frequently so it becomes interesting to do it by remote control, the method 200 does not need to be run through completely. An additional selection option for a system going in learning mode then may allow the universal remote control device 2 to recall the image 14 of the original remote control device of the appliance for which the functions need to be extended and request the user to press the button to which a new function needs to be assigned. After the remote control signal has been detected, a corresponding code is assigned to the imaged button, so that in the future pressing the imaged button on the touch screen initiates the system to transmit a remote control signal corresponding with the remote control signal received from the original remote control device. In principle, no function will have been assigned to this button yet. If a function was already assigned to the button, the user is asked to confirm the new assignment thereby removing the old assigned code, prior to continuation.

A further embodiment of the present invention wherein configuration can be performed quicker comprises a method of incorporating the remote control functions of an original remote control device wherein a step of automatically selecting a selected key of the image 14 of the original remote control device, and displaying it on the touch screen 6 of the universal remote control device 2 is included. Furthermore, to simplify and speed up the updating of the universal remote control device 2, there can be an automatic learn mode wherein the storage of the code is not in a decision step, but wherein the learning function is performed by the system highlighting a button, the user pressing the corresponding button on the original remote control device, the system giving a sign, e.g. a sound, if the signal is detected and the system storing a fingerprint of the remote control signal automatically, thereby automatically selecting a following key and prompting for the user to press the following key on the original remote control device. This mode allows the user to configure the universal remote control device 2 just by pressing the buttons on the original remote control device, corresponding with the imaged buttons of the image 14 of the original remote control device.

In an alternative embodiment, if the original remote control device is not available anymore, the system could additionally use a different method of updating, e.g. by receiving the remote control signals from a computer set-up having a signal emitter which transmits the code using a source from a database or a CD-ROM. Another alternative could be using a direct link between the universal remote control device 2 and a PC, having a local database of codes or being connected to a network.

In another embodiment of the current invention, the universal remote control device 2 may additionally have pre-stored command codes in a read-only memory for remote control devices of one or more predetermined electronic appliances. In this way the configuration procedure as described above may be shortened. If the user makes clear which set of pre-stored command codes needs to be installed, e.g. by entering a specific series number of the original remote control device, automatic assignation of codes to the different imaged buttons of the remote control device may be performed by the universal remote control device, limiting the effort for the user to taking a good snapshot and give the command to start the fast learning procedure. In a more advanced version of this embodiment, the universal remote control device 2 may comprise means for automatic recognition of a type and brand of original remote control devices, allowing the universal remote control device 2 to select a database set of pre-stored command codes without interference of the user. The effort for the user is then limited to taking a good snapshot of the original remote control device. The pre-stored command codes may originally be stored in a read-only memory, whereby the learned command codes are additionally stored in a read-write random access memory or a flash memory. Method 200 is then used for incorporating functions of original remote control devices having no corresponding pre-stored commands in the database.

In a further embodiment of the current invention, the universal remote control system as described in the above embodiments also comprises a mobile phone function. The universal remote control device 2 then further comprises an antenna, a transmitter chain and a receiver chain of the mobile phone. A duplexer may be provided, which allows to split the frequencies to distinguish between an incoming message and a message that is to be transmitted. The transmitting chain and the receiving chain comprise an analogue/digital converter and a digital processing device. The transmitting chain can have a microphone and/or camera as an input means and the receiving chain can have a loudspeaker and/or an alphanumeric display as an output means. The display 6, present in the remote control device 2, can be used as a touch screen for both remote control actions and mobile phone actions and the camera 20 can be used for imaging original remote control devices and MMS functions of the mobile phone. In other words, the imaging function of the camera 20 of the universal remote control device 2 and the imaging function of the MMS means available in many mobile phones could be performed by one single camera 20. In this way the number of components is reduced in the device performing both functions. Additional advantages can be seen from the following: as in many modern households all members have their own mobile phone which they carry along with them, according to the present embodiment of the invention, every member can have its own version of the universal remote control device carried along with him. An additional advantage is that the universal remote control device 2 can be adjusted to the specific needs of every user in the household.

The present invention also includes a software product for carrying out any of the methods of the present invention on a remote control device having a processing means such as a microprocessor, a programmable digital logic element such as a programmable gate array, a programmable array logic, a programmable logic array, a field programmable gate array. The software product may be stored on any suitable machine readable medium, e.g. magnetic storage media such as diskette or diskettes, magnetic tape; optical storage media such as CD-ROM, DVD-ROM, solid state memories, etc. The software product may comprise code segments for updating a universal remote control device suitable for controlling a plurality of electronic apparatuses. The software product may comprise code segments for displaying an image of a first remote control device on a touch screen of the universal remote control device, the image showing images of buttons of the first remote control devices. The images may be stored in any suitable image format. The software product may comprise code for applying a learning function to an image of at least one of the buttons of the first remote control device wherein applying the learning function comprises recognising said at least one of the buttons of the first remote control device on the displayed image, detecting a first remote control signal associated with said recognised at least one of the buttons of the first remote control device after actuation of said at least one of the buttons of the first remote control device. The software product may also comprise code segments for associating a second remote control signal corresponding to the first remote control signal with the image of the recognised control button.

The software product may also comprise code segments for capturing the image of the first remote control device. The software product may also comprise code segments for storing of the image of the first remote control device, e.g. in a non-volatile or volatile memory.

It is to be understood that although preferred embodiments, specific constructions and configurations, as well as materials, have been discussed herein for devices according to the present invention, various changes or modifications in form and detail may be made without departing from the scope and spirit of this invention.

1. A universal remote control device (2) for controlling a plurality of electronic appliances, the universal remote control device (2) comprising means (20) for receiving an image (14) of a first remote control device, a touch screen (6), a signal detector (16) and a processing means (102), wherein
said touch screen (6) is adapted for displaying the image (14) of said first remote control device,
said signal detector (16) is adapted for receiving first remote control signals associated with at least one control button of said first remote control device,
said processing means (102) is adapted for recognising control buttons on said image (14) of said first remote control device and furthermore is adapted for associating second remote control signals corresponding to said first remote control signals with the image (14) of the recognised control buttons.

2. A universal remote control device (2) according to claim 1, wherein said means (20) for receiving an image (14) of a first remote control device is a camera for capturing an image (14) of said first remote control device.

3. A universal remote control device (2) according to claim 1, further comprising means for operating as a mobile phone, wherein said means (20) for receiving an image (14) and said touch screen (6) are adapted for being used for graphic multimedia messaging service functions and said touch screen (6) is also adapted for being used as keyboard for mobile phone functions.

4. A method (200) for updating a universal remote control device (2) for controlling a plurality of electronic apparatuses, comprising
displaying an image (14) of a first remote control device on a touch screen (6) of the universal remote control device (2), the image (14) showing images of buttons of the first remote control devices,
applying a learning function to an image of at least one of the buttons of the first remote control device wherein applying the learning function comprises
recognising (212) said at least one of the buttons of the first remote control device on the displayed image (14),
detecting (222) a first remote control signal associated with said recognised at least one of the buttons of the first remote control device after actuation of said at least one of the buttons of the first remote control device,
associating a second remote control signal corresponding to the first remote control signal with the image of the recognised control button.

5. A method (200) for updating a universal remote control device (2) according to claim 4, furthermore comprising capturing (208) the image (14) of the first remote control device.

6. A method (200) for updating a universal remote control device (2) according to claim 4, furthermore comprising storing of the image (14) of the first remote control device.

7. A computer program product for executing any of the methods as claimed in claim 4 when executed on a remote control device with a processing means.

8. A machine readable data storage device storing the computer program product of claim 7.
